(19) United States
(12) Patent Application Publication
(10) Pub. No.: US 2018/0299668 A1
(43) Pub. Date: Oct. 18, 2018

(54) OPTICAL MODELING METHOD AND ELECTRONIC APPARATUS USING THE SAME

(71) Applicants: LITE-ON ELECTRONICS (GUANGZHOU) LIMITED, GUANGZHOU (CN); Lite-On Technology Corporation, Taipei (TW)

(72) Inventors: Shih-Chang Wang, Taipei (TW); Wei-Wen Shih, Taipei (TW); Pin-Hao Hsu, Taipei (TW)

(73) Assignees: LITE-ON ELECTRONICS (GUANGZHOU) LIMITED, GUANGZHOU (CN); Lite-On Technology Corporation, Taipei (CN)

(21) Appl. No.: 15/609,048

(22) Filed: May 31, 2017

(30) Foreign Application Priority Data
Apr. 18, 2017 (TW) 106112921

(51) Int. Cl. G02B 27/00; G02B 27/09; F21V 5/04

(52) U.S. Cl. CPC G02B 27/0012; G02B 27/0955; F21V 5/04; G02B 27/0927

(57) ABSTRACT

An optical modeling method and an electronic apparatus for building a target lens model are provided. The optical modeling method includes: calculating and generating a first lens model according to a spatial intensity distribution of a light source and a first target intensity distribution; introducing an external shape of the light source and calculating a first intensity distribution according to the spatial intensity distribution and the first lens model; obtaining a first difference level by comparing the first target intensity distribution and the first intensity distribution; taking the first lens model as the target lens model if the first difference level is not greater than preset threshold; otherwise, correcting the first target intensity distribution to a second target intensity distribution according to the first difference level, and calculating and generating a second lens model according to the spatial intensity distribution of the light source and the second target intensity distribution.

### CROSS-REFERENCE TO RELATED APPLICATION

This application claims the priority benefit of Taiwan application serial no. 106112921, filed on Apr. 18, 2017. The entirety of the above-mentioned patent application is hereby incorporated by reference herein and made a part of this specification.

### BACKGROUND OF THE INVENTION

### 1. Field of the Invention

The invention relates to a modeling method, and particularly relates to an optical modeling method for building a lens model and an electronic apparatus using the optical modeling method.

### 2. Description of Related Art

In recent years, as the improvement of luminous efficiency and lifetime of light emitting diode (LED), along with the component features and advantages thereof, such as low power consumption, low pollution, high-efficiency, high speed of response, small volume, light weight, and installability on various kinds of surfaces, LED has been positively applied in various optical fields. Take the use of. LED on illumination for example, many illuminating devices using LED packaging structures on the light sources (such as light bulbs, street lamps, flashlights, etc.) or on other relevant components have been developed.

In designing such illuminating devices, the optical design is often performed by adding optical lens, diffuser plates, or other optical components in the light path of the LED packaging structures to change the optical performance thereof (for example, to change the light emitting angle and increase the color uniformity), and to obtain an expected light shape distribution, so that the light emitted by the whole light system satisfies the designer's requirements. However, the current designing method takes a lot of time because the light distribution curve of the lens is unpredictable.

### SUMMARY OF THE INVENTION

The invention provides an optical modeling method and an electronic apparatus using the same, that effectively build a lens model, so that a light source generates a light shape that is close to a target light shape after passing the lens model, and time for designing the lens is saved.

The optical modeling method of the invention is adapted for an electronic apparatus to build a target lens model. The optical modeling method includes: calculating and generating a first lens model according to a spatial intensity distribution of a light source and a first target intensity distribution; introducing an external shape of the light source and calculating a first intensity distribution according to the spatial intensity distribution and the first lens model; obtaining a first difference level by comparing the first target intensity distribution and the first intensity distribution; taking the first lens model as the target lens model if the first difference level is not greater than a preset threshold; if the first difference level is greater than the preset threshold, correcting the first target intensity distribution to a second target intensity distribution according to the first difference level, and calculating and generating a second lens model according to the spatial intensity distribution of the light source and the second target intensity distribution.

The electronic apparatus of the invention is adapted to build a target lens model, and includes an input device, a storage device, and a processing device. The input device is configured to receive a first target intensity distribution. The storage device is configured to store a plurality of modules. The processing device is coupled to the input device and the storage device and configured to load and execute the modules in the storage device. The modules include a model calculating module, an intensity distribution calculating module, a difference calculating module, a model deciding module, and a compensating module. The model calculating module is configured to calculate and generate a first lens model according to a spatial intensity distribution of a light source and the first target intensity distribution. The intensity distribution calculating module is configured to introduce an external shape of the light source and calculates a first intensity distribution according to the spatial intensity distribution and the first lens model. The difference calculating module is configured to obtain a first difference level by comparing the first target intensity distribution and the first intensity distribution and determine whether the first difference level is greater than a preset threshold. If the first difference level is not greater than the preset threshold, the model deciding module takes the first lens model as the target lens model. If the first difference level is greater than the preset threshold, the compensating module corrects the first target intensity distribution to a second target intensity distribution according to the first difference level, and the model calculating module further calculates and generates a second lens model according to the spatial intensity distribution of the light source and the second target intensity distribution.

Based on the above, the optical modeling method and the electronic apparatus using the same of the invention first utilize the first target intensity distribution to calculate the first lens model, and utilize the external shape and the spatial intensity distribution of the light source, and the calculated first lens model to calculate the first intensity distribution. Self-compensating according to the difference level between the first intensity distribution and the first target intensity distribution, then the target lens model may be obtained by recursive calculation. Accordingly, after passing the target lens model, the light source generates a light shape that is close to the target intensity distribution, and time for designing the target lens model is saved as well.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic block diagram of an electronic apparatus according to an embodiment of the invention.

FIG. 2 is a flowchart of an optical modeling method according to an embodiment of the invention.

FIG. 3 is a schematic view of a target intensity distribution according to an embodiment of the invention.

FIG. 4 is a schematic view of a lens model according to an embodiment of the invention.

FIG. 5 is a schematic view of an intensity distribution according to an embodiment of the invention.

FIG. 6 is a schematic view of a surface light source according to an embodiment of the invention.

FIG. 7 is a schematic view of a difference level of intensity distributions according to an embodiment of the invention.

### DESCRIPTION OF THE EMBODIMENTS

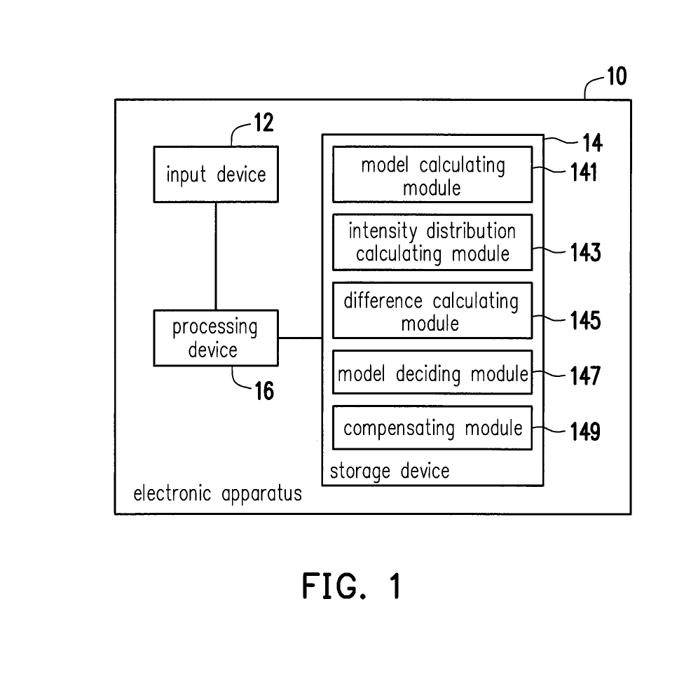

FIG. 1 is a schematic block diagram of an electronic apparatus according to an embodiment of the invention. An electronic apparatus 10 of this embodiment is configured to build a target lens model for a light source to generate a light shape or intensity distribution that is close to an expected target intensity distribution after light of the light source passes the target lens model. In this embodiment, the electronic apparatus 10 is, for example, a personal computer, a mobile phone, a tablet computer, a server, or other apparatuses having an operational function, which includes at least an input device 12, a storage device 14, and a processing device 16. Functions of each of these devices are described as follows:

The input device 12 is a keyboard, a mouse, etc., for example, configured to receive an input signal. In this embodiment, the input signal received by the input device 12 includes, for example, a first target intensity distribution. The first target intensity distribution that is inputted is, for example, a one-, two-, or three-dimensional spatial intensity distribution, but the embodiment is not limited thereto.

The storage device 14 is, for example, a fixed or mobile random access memory (RAM), read-only memory (ROM), flash memory, or any other similar component, or any combination of the above components in any form. In this embodiment, the storage device 14 is configured to store a model calculating module 141, an intensity distribution calculating module 143, a difference calculating module 145, a model deciding module 147, and a compensating module 149.

The processing device 16 is, for example, a central processing unit (CPU), or other programmable microprocessor, digital signal processor (DSP), programmable controller, application specific integrated circuits (ASIC), programmable logic device (PLD) of general use or special use, or any other similar device, or any combination of the above devices, coupled to the input device 12 and the storage device 14.

In this embodiment, the module stored in the storage device 14 is a computer program, for example, which is loaded by the processing device 16 to execute an optical modeling method according to this embodiment. An embodiment is provided as follows to describe the steps of the method in detail.

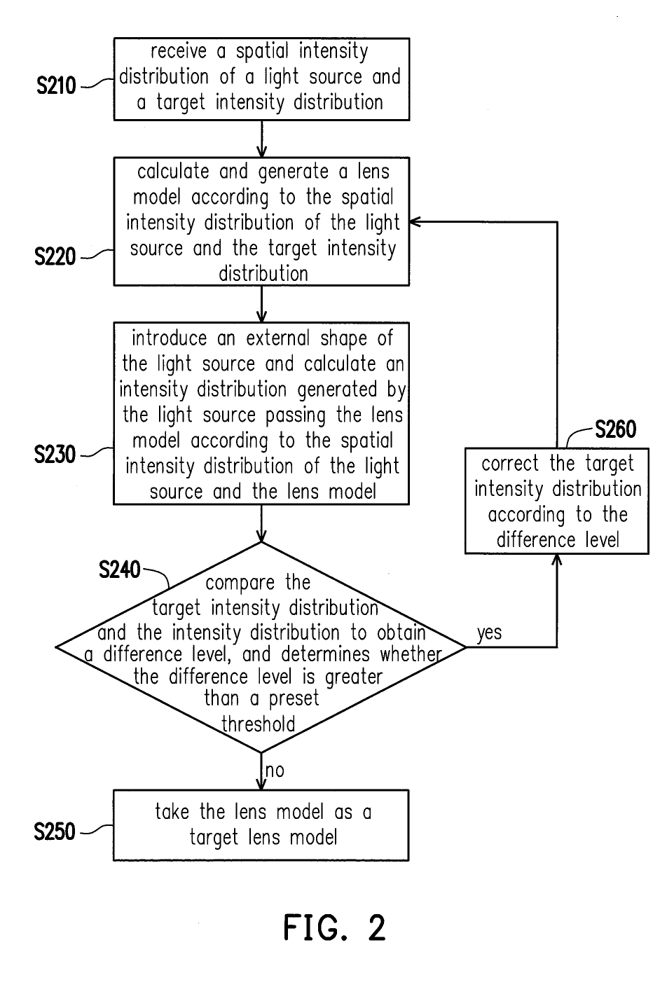

FIG. 2 is a flowchart of the optical modeling method according to an embodiment of the invention. Please refer to FIG. 1 and FIG. 2. The method according to this embodiment is adapted for the electronic apparatus 10 of the FIG. 1. The steps of the optical modeling method of this embodiment are provided in detail as follows with reference to the components of the electronic apparatus 10 shown in FIG. 1.

In step S210, the processing device 16 receives a spatial intensity distribution of a light source and an expected first target intensity distribution from the input device 12. The spatial intensity distribution of the light source is, for example, designed when the light source is packaged, and indicates the intensity in each position in the space when the light source is illuminating. In another embodiment, the spatial intensity distribution of the light source is, for example, stored in advance in the storage device 14 to be loaded by the processing device 16 in step S210. On the other hand, users may input the expected first target intensity distribution by the input device 12, for example. The first target intensity distribution is the intensity distribution in each position in the space which a user expects a light source to reach after passing the designed target lens model.

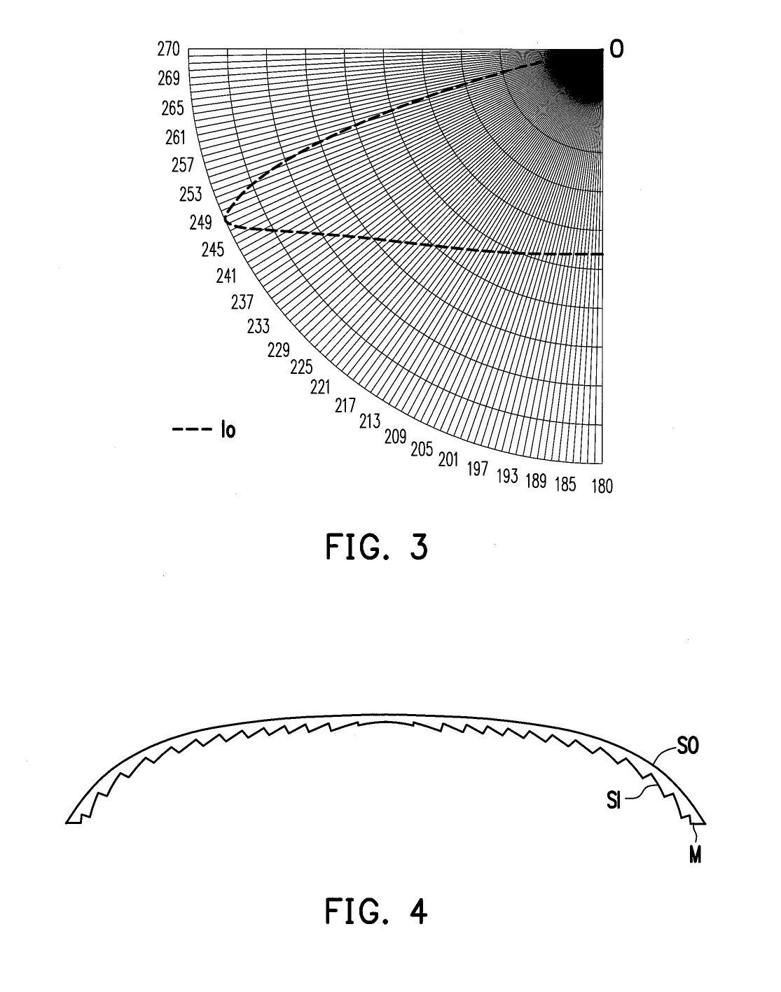

FIG. 3 is a schematic view of a target intensity distribution according to an embodiment of the invention. Please refer to FIG. 3, the first target intensity distribution Iₒ illustrates an intensity distribution of the third quadrant of a section surface of space in a polar coordinate, and the distance between the first target intensity distribution Iₒ and the origin O depicted in FIG. 3 is positively correlates with an intensity. Note that the first target intensity distribution Iₒ, as shown in FIG. 3, is a two-dimensional intensity distribution, but it can also be substituted by a three-dimensional spatial intensity distribution of cylindrical symmetry. In other words, the first target intensity distribution Iₒ according to the embodiment of FIG. 3 is simply an example. Persons having ordinary skill in the art should be able to present the target intensity distribution in other ways according to their needs.

Then, in step S220, the processing device 16 executes the model calculating module 141 to generate a lens model (e.g., a first lens model) according to the spatial intensity distribution of the light source and the first target intensity distribution Iₒ, so that the intensity distribution that is obtained after the light source passes the generated lens model is close to the first target intensity distribution Iₒ.

FIG. 4 is a schematic view of the lens model according to an embodiment of the invention. In this embodiment, the processing device 16 first receives a plurality of parameters such as the length, width, height, and refractive index that define the lens model from the input device 12, and then simulates a first lens model M with a program based on these parameters. This embodiment does not specify herein the details of simulating the first lens model M with the program, since persons having ordinary skill in the art should acknowledge enough teachings from knowledge regarding optical simulation. Note that the light source used in step S220 to generate the first lens model M is assumed to be a point light source in this embodiment.

In step S230, the processing device 16 executes the intensity distribution calculating module 143 to introduce the external shape of the light source and calculate the intensity distribution (e.g., a first intensity distribution) generated by the light source passing the first lens model M according to the spatial intensity distribution of the light source and the first lens model M which is simulated in step S220.

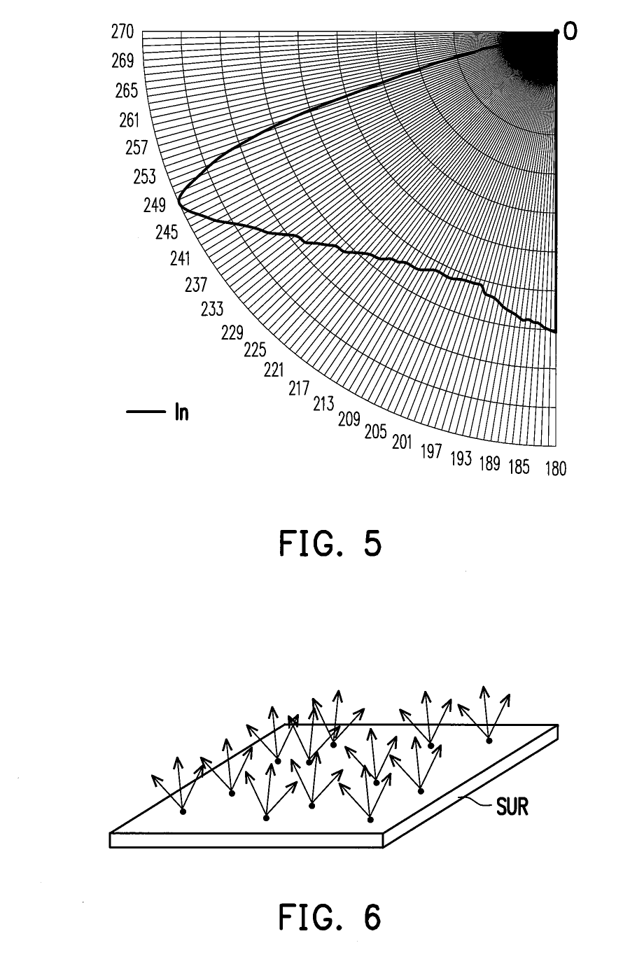

FIG. 5 is a schematic view of the intensity distribution according to an embodiment of the invention. In this embodiment, the processing device 16 obtains the external shape of the light source through the input device 12 or the storage device 14, for example. Then the intensity distribution calculating module 143 (for example, optical software tools such as LightTools, TracePro, ASAP, etc.) is executed. After introducing the external shape of the light source, the intensity distribution calculating module 143 simulates a transmitting light, a reflective light, and a stray light produced by the light source passing the first lens model M according to the external shape of the light source, the spatial intensity distribution, and the first lens model M of FIG. 4 and calculates a first intensity distribution In.

FIG. 6 is a schematic view of a surface light source according to an embodiment of the invention. Please refer to FIG. 4 and FIG. 6. Since the first lens model M simulated in step S220 may include a plurality of irregular surfaces (for example, an inner surface SI), a lot of stray lights may be produced after introducing the external shape of the light source. For instance, as shown in FIG. 6, assume that the external shape of the light source being a surface light source SUR instead of a point light source, the surface light source SUR may be seen as a plurality of point light sources gathering on a surface. Accordingly, each point light source on the surface of the surface light source SUR irradiates to different positions on the irregular surface of the first lens model M, thus producing the stray lights. In this embodiment, the stray lights include a primary reflection stray light, produced by direct irradiation of the light source to the irregular inner surface SI of the first lens model M, and a secondary reflection stray light, produced by irradiation of the light source to the inner surface SI, reflected by an outer surface SO and then reflected by the inner surface SI.

The stray lights may cause the light source to generate an intensity distribution far from the first target intensity distribution Iₒ after the light source passes the first lens model M generated in step S220.

In step S240, the processing device 16 executes the difference calculating module 145 to obtain a difference level (e.g., a first difference level) between the first target intensity distribution Iₒ and the intensity distribution In calculated in step S230 and to determine whether the difference level is greater than a preset threshold, in order to decide if the intensity distribution In calculated in step S230 is acceptable. In this embodiment, the preset threshold is preset in the processing device 16 or the storage device 14 but not limited thereto. In other embodiments, the preset threshold is, for example, received by the input device 12 before the processing device 16 executes step S240 for the first time.

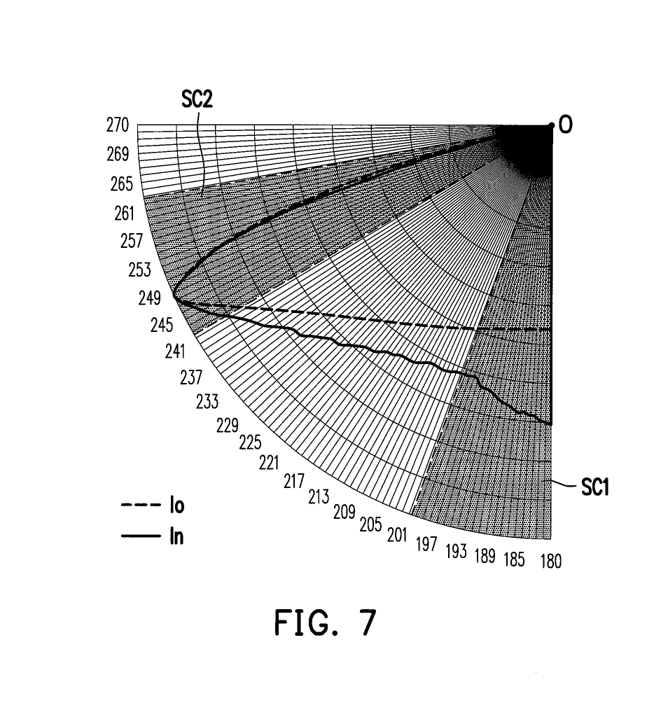

FIG. 7 is a schematic view of a difference level of intensity distributions according to an embodiment of the invention. FIG. 7 apposes the first target intensity distribution Iₒ and the first intensity distribution In calculated in step S230 for convenience in comparing. In this embodiment, at each angle, the processing device 16 calculates a ratio (e.g., In/Iₒ) of the first intensity distribution In to the first target intensity distribution Iₒ or calculates a difference (e.g., In−Iₒ) between the first intensity distribution In and the first target intensity distribution Iₒ as the first difference level, for example. If the first difference level is greater at a particular angle, it means that the stray light affects more significantly at this particular angle. In this embodiment, the first target intensity distribution Iₒ is adjusted correspondingly in the following steps, in order to compensate for the effects of the stray light in advance. Details thereof are provided in the following paragraphs.

If the first difference level is not greater than the preset threshold, which means that the first intensity distribution In calculated in step S230 is close enough to the first target intensity distribution Iₒ and thus is acceptable, then the process proceeds to step S250, where the processing device 16 executes the model deciding module 147 to output the first lens model M generated in step S220 as the target lens model.

Otherwise, if at least one of the first differences is greater than the preset threshold, then the process proceeds to step S260, where the processing device 16 executes the compensating module 149 to correct the first target intensity distribution Iₒ to a second target intensity distribution I₀′ according to the first difference level. Then the process returns to step S220 to generate a lens model (e.g., a second lens model) according to the spatial intensity distribution of the light source and the corrected second target intensity distribution Iₒ′.

Please refer to FIG. 7 again. In step S260, the processing device 16 executes the compensating module 149 to correct the first target intensity distribution Iₒ to the second target intensity distribution Iₒ′ according to the first difference level. Specifically, the processing device 16, for example, divides the space into a plurality of sections by degree or by distance to the origin O, and then compensates each of the sections separately. For instance, assume that an average of the first difference levels on every angles in a first section SC1 is a first average difference level, the processing device 16 divides the intensity of the first target intensity distribution Iₒ in the first section SC1 by the first average difference level as a compensation; assume that an average of the first difference levels on every angles in a second section SC2 is a second average difference level, the processing device 16 divides the intensity of the first target intensity distribution Iₒ in the second section SC2 by the second average difference level as a compensation, and so on, to obtain the compensated second target intensity distribution Iₒ′. In this embodiment, the first average difference level in the first section SC1 is evidently greater than the second average difference level in the second section SC2. Therefore, a correction amount of the first target intensity distribution in the first section SC1 is greater than a correction amount of the first target intensity distribution in the second section SC2.

As a result, the second lens model generated according to the spatial intensity distribution of the light source and the corrected second target intensity distribution Iₒ′ in step S220 is closer to the target lens model.

After the second lens model is generated, the process proceeds to step S230, where the processing device 16 executes the intensity distribution calculating module 143 again to introduce the external shape of the light source and calculate an intensity distribution (e.g., a second intensity distribution) generated by the light source passing the second lens model according to the spatial intensity distribution of the light source and the second lens model simulated in step S220.

Then, in step S240, the processing device 16 executes the difference calculating module 145 to obtain a second difference level by comparing the first target intensity distribution Iₒ and the second intensity distribution and to determine whether the second difference level is greater than the preset threshold, in order to decide whether to accept the second intensity distribution or not. If the second difference level is not greater than the preset threshold, then the processing device 16 decides to accept the second intensity distribution, and the process proceeds to step S250, where the processing device 16 executes the model deciding module 147 to output the second lens model as the target lens model. Otherwise, the process proceeds to step S260, where the processing device 16 executes the compensating module 149 again to correct the second target intensity distribution Iₒ′ to a third target intensity distribution according to the second difference level. Then the process returns to step S220 to generate a third lens model according to the spatial intensity distribution of the light source and the corrected third target intensity distribution. The specific implementation method of similar steps is provided in the above paragraphs and thus not to be repeated herein.

Accordingly, by performing the optical modeling method according to the embodiments of the invention, the stray light that may be generated is compensated in advance in order to obtain the target lens model more efficiently so that the intensity distribution obtained after the light source passes the target lens model is close to the first target intensity distribution.

Note that, in an embodiment, the processing device 16 further records the first intensity distribution, the first lens model and the first target intensity distribution, and records the second intensity distribution, the second lens model and the second target intensity distribution, etc. in the storage device 14 to construct a calculation database. Thereby, after the first target intensity distribution is obtained in step S210, the processing device 16 may directly access the calculation database from the storage device 14 and correct the first target intensity distribution in advance according to the data in the database, which saves significant time for calculation.

To sum up, the optical modeling method and the electronic apparatus using the same provided in the embodiments of the invention first utilize the first target intensity distribution to calculate the first lens model, and utilize the external shape and the spatial intensity distribution of the light source, and the first lens model to calculate the first intensity distribution. Self-compensating according to the difference level between the first intensity distribution and the first target intensity distribution, the target lens model may be obtained with recursive calculation. Accordingly, after passing the target lens model, the light source generates the light shape that is close to the target intensity distribution, and time for designing the target lens model is saved as well.

It will be apparent to those skilled in the art that various modifications and variations can be made to the disclosed embodiments without departing from the scope or spirit of this invention. In view of the foregoing, it is intended that the invention covers modifications and variations provided that they fall within the scope of the following claims and their equivalents.

What is claimed is:

1. An optical modeling method, adapted for an electronic apparatus to build a target lens model, the optical modeling method comprising:
calculating and generating a first lens model according to a spatial intensity distribution of a light source and a first target intensity distribution;
introducing an external shape of the light source and calculating a first intensity distribution according to the spatial intensity distribution and the first lens model;
obtaining a first difference level by comparing the first target intensity distribution and the first intensity distribution;
taking the first lens model as the target lens model if the first difference level is not greater than a preset threshold; and
if the first difference level is greater than the preset threshold, correcting the first target intensity distribution to a second target intensity distribution according to the first difference level, and calculating and generating a second lens model according to the spatial intensity distribution of the light source and the second target intensity distribution.

2. The optical modeling method according to claim 1, wherein if the first difference level is greater than the preset threshold, the optical modeling method further comprises:
calculating a second intensity distribution according to the external shape of the light source, the spatial intensity distribution, and the second lens model;
obtaining a second difference level by comparing the first target intensity distribution and the second intensity distribution;
taking the second lens model as the target lens model if the second difference level is not greater than the preset threshold; and
if the second difference level is greater than the preset threshold, correcting the second target intensity distribution to a third target intensity distribution according to the second difference level, and calculating and generating a third lens model according to the spatial intensity distribution of the light source and the third target intensity distribution.

3. The optical modeling method according to claim 1, wherein calculating and generating the first lens model according to the spatial intensity distribution of the light source and the first target intensity distribution comprises:
setting at least one first parameter of the first lens model; and
calculating and generating the first lens model according to the spatial intensity distribution of the light source and the first target intensity distribution based on the at least one first parameter,
wherein the at least one first parameter comprises at least one of a length, a width, a height, and a refractive index of the first lens model.

4. The optical modeling method according to claim 1, wherein introducing the external shape of the light source and calculating the first intensity distribution according to the spatial intensity distribution and the first lens model comprises:
introducing the external shape of the light source and simulating a transmitting light, a reflective light, and a stray light produced by the light source passing the first lens model to calculate the first intensity distribution,
wherein the stray light comprises a primary reflection stray light and a secondary reflection stray light.

5. The optical modeling method according to claim 1, further comprising:
recording the first intensity distribution, the first lens model and the first target intensity distribution.

6. An electronic apparatus adapted to build a target lens model, the electronic apparatus comprising:
an input device, configured to receive a first target intensity distribution;
a storage device, configured to store a plurality of modules; and
a processing device coupled to the input device and the storage device, and configured to load and execute the modules, wherein the modules comprise:
a model calculating module configured to calculate and generate a first lens model according to a spatial intensity distribution of a light source and the first target intensity distribution;
an intensity distribution calculating module configured to introduce an external shape of the light source and calculate a first intensity distribution according to the spatial intensity distribution of the light source and the first lens model;
a difference calculating module configured to obtain a first difference level by comparing the first target intensity distribution and the first intensity distribution and determine whether the first difference level is greater than a preset threshold;
a model deciding module configured to take the first lens model as the target lens model if the first difference level is not greater than the preset threshold; and
a compensating module configured to correct the first target intensity distribution to a second target intensity distribution according to the first difference level if the first difference level is greater than the preset threshold, wherein the model calculating module further calculates and generates a second lens model according to the spatial intensity distribution of the light source and the second target intensity distribution.

7. The electronic apparatus according to claim 6, wherein if the first difference level is greater than the preset threshold, the intensity distribution calculating module further calculates a second intensity distribution according to the external shape of the light source, the spatial intensity distribution, and the second lens model, and
the difference calculating module further obtains a second difference level by comparing the first target intensity distribution and the second intensity distribution and determines whether the second difference level is greater than the preset threshold,
wherein the model deciding module takes the second lens model as the target lens model if the second difference level is not greater than the preset threshold, and
wherein if the second difference level is greater than the preset threshold, the compensating module corrects the second target intensity distribution to a third target intensity distribution according to the second difference level, and the model calculating module further calculates and generates a third lens model according to the spatial intensity distribution of the light source and the third target intensity distribution.

8. The electronic apparatus according to claim 6, wherein the input device is further configured to receive at least one first parameter of the first lens model,
wherein when generating the first lens model, the model calculating module calculates and generates the first lens model according to the spatial intensity distribution of the light source and the first target intensity distribution based on the at least one first parameter, and
wherein the at least one first parameter comprises at least one of a length, a width, a height, and a refractive index of the first lens model.

9. The electronic apparatus according to claim 6, wherein the intensity distribution calculating module simulates a transmitting light, a reflective light, and a stray light produced by the light source passing the first lens model according to the external shape of the light source and the spatial intensity distribution to calculate the first intensity distribution,
wherein the stray light comprises a primary reflection stray light and a secondary reflection stray light.

10. The electronic apparatus according to claim 6, wherein the storage device is further configured to record the first intensity distribution, the first lens model and the first target intensity distribution.
